(19) United States
(12) Patent Application Publication
(10) Pub. No.: US 2025/0131782 A1
(43) Pub. Date: Apr. 24, 2025

(54) AUTOMATIC GATE SYSTEM FOR OPENING WHILE DRIVING THEREINTO

(71) Applicant: ROY SABAH, BAT YAM (IL)

(72) Inventor: ROY SABAH, BAT YAM (IL)

(21) Appl. No.: 19/007,608

(22) Filed: Jan. 2, 2025

Related U.S. Application Data
(63) Continuation-in-part of application No. 17/976,825, filed on Oct. 30, 2022.
(60) Provisional application No. 63/274,018, filed on Nov. 1, 2021.

(51) Int. Cl. G07C 9/10; G07C 9/21; G07C 9/28; H04W 4/021; H04W 4/44

(52) U.S. Cl. CPC G07C 9/10; G07C 9/21; G07C 9/28; H04W 4/021; H04W 4/44

(57) ABSTRACT

A gate system, including a transceiver for a vehicle, for continuously transmitting transmission including requests including information including location of the vehicle in relation to the gate, and at least an allowed code, and a device for the gate, including a transceiver, for continuously receiving the continuous transmission, and a controller including the allowed code, for continuously approving the requests according to the allowed code, and for opening the gate only once the requests include the information of the transmitted transmission indicating that the vehicle is sufficiently near the gate.

### CROSS-REFERENCE TO RELATED APPLICATIONS

This application is a Continuation-in-Part of U.S. patent application Ser. No. 17/976,825, filed Oct. 30, 2022, which claims the benefit of priority from U.S. Provisional Patent Application No. 63/274,018, filed Nov. 1, 2021, the disclosure of which is incorporated herein by reference.

### TECHNICAL FIELD

The invention relates to the field of controllable gates for being openable upon arrival of vehicles.

### BACKGROUND

Gates being controllable by wireless transmission are disadvantaged of being openable only after waiting several seconds from the request. Requesting several seconds before the arrival allows non-authorized vehicles to enter.

There is a long felt need to provide a solution to the above-mentioned and other problems of the prior art.

### SUMMARY

A vehicle gate system, including:
a transceiver for the vehicle, for continuously transmitting transmission including requests including
information including location of the vehicle in relation to the gate, and at least an allowed code; and
a device for the gate, including:
   a transceiver, for continuously receiving the continuous transmission; and
   a controller including the allowed code,
   for continuously approving the requests according to the allowed code, and
   for opening the gate only once the requests include the information of the transmitted transmission indicating that the vehicle is sufficiently near the gate.

### BRIEF DESCRIPTION OF THE DRAWINGS

Embodiments, features, and aspects of the invention are described herein in conjunction with the following drawings in which

FIG. 1 depicts a first request to open a gate;

FIG. 2 depicts a second request to open the gate of FIG. 1;

FIG. 3 depicts a third request to open the gate of FIG. 1;

FIG. 4 depicts a fourth request to open the gate of FIG. 1; and

FIG. 5 depicts the contest between transceiver and transceiver.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

An access control system is configured to identify a user and to automatically open an access barrier when the user approaches the access barrier.

The term “vehicle” refers herein to vehicles, wheel chairs, robots, etc.

The system may include in a vehicle a wireless communications controller, for example a Wi-Fi communications component connected to a USB socket inside the vehicle continuously receiving power from the vehicle, and on the side of the gate a modem which communicates with the communications controller. The gate modem may include a Wi-Fi modem.

As the vehicle approaches the modem at the gate, encrypted information is transmitted between the vehicle communications controller and the gate modem. Optionally, the encrypted information is 128 bit. The Wi-Fi transmissions between the vehicle communications controller and the gate modem include preselected fixed time durations, for example, 100 milliseconds.

The wireless communications between the vehicle communications controller and the gate modem may include any one of the following communications modes: mobile phone communications, Bluetooth communication and Wi-Fi especially of 2.4 GHz which may be encrypted, nRF24, nRF52, among other wireless communications modes.

The gate modem may use scanning networks to detect the vehicle communications controller to allow transmitting the information via a secure communications connection between the gate modem and the vehicle communications controller.

As the vehicle communication controller approaches the gate modem, it may receive a transmission signal from the gate modem and may responsively start transmitting the information back to the modem.

Upon the gate modem receiving the desired information, if the information is encrypted, it may convert the encryption into plain text and may request authentication from a server associated with a company which provides the service. Additionally, or alternatively, authentication may be performed by an access authentication component inside the gate modem.

In some embodiments, to prevent duplication and copying of frequency or the information, the information sent from the vehicle communications controller may be changed in every transmission. The transmitted information may include, for example, a serial number of the controller combined with a random number, or an increasing number, or the current date and time, among other information.

In some embodiments, the gate modem may be a 4th generation data modem (and not a dial-up modem) which may be controlled through a dedicated application program on a mobile phone, and/or a remote control and/or RF communication devices operating at a frequency of 2.4 GHz and with a range of up to 100 meters.

In some embodiments, the system may include GPS which may detect when the vehicle is a predetermined distance from the gate and may automatically activate the vehicle communications controller. Alternatively, the system may include a sensor to detect that the vehicle is not moving, and the vehicle communications controller may automatically send a transmission signal to the gate modem. Optionally, the vehicle communications controller may activate a hotspot which may be detected and identified by the gate modem, and to which the gate modem may securely connect for the purpose of transmitting information.

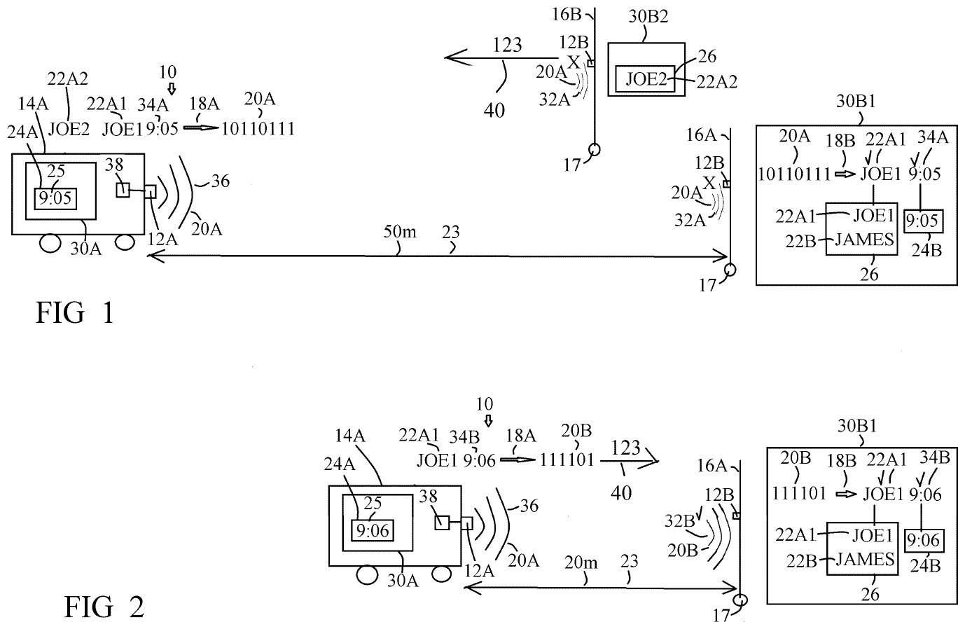

FIG. 1 depicts a first request to open a gate.

A vehicle gate system 10 includes an allowed transceiver 12A for the vehicle 14A and a transceiver 12B for the gate 16A.

Transceiver 12A and transceiver 12B use correlated encoding 18A and decoding 18B.

At a first transmittance being while vehicle 14A is far, say 50 meters, transceiver 12A transmits a request 20A, being after encoding 18A according to an example, the code 10110111.

Code 10110111 being request 20A is produced by including code 22A1 allowed by gate 16A such as “JOE1” being the password, combined with allowed code 22A2 allowed by gate 16B such as “JOE2”, and combined with the hour/time 34A, such as “9:05” retrieved from time 25 of the clock 24A, and encoding (18A) the combination of codes 22A1, 22A2 and time 34A.

Controller 30B1 of gate 16A receives request 20A from transceiver 12B, and decodes (18) request 20A to “JOE1”, “JOE2”, and “9.05”.

Controller 30B1 of gate 16A approves “JOE1” in its database 26, and approves “9:05” upon checking in its clock 24B, thus, controller 30B1 of gate 16A produces a token code 40, such as 123. Transceiver 12B transmits token 40 to transceiver 12A.

However, controller rejects request 20A due to low transmittance intensity 32A measured by a transmittance intensity meter embedded in transceiver 12B, such as used by RSSI.

Large amount of computing power is required for password-based authentication, being in contrast to small amount of computing power required for token-based authentication.

Token-based authentication is different from traditional password-based or server-based authentication techniques. Tokens offer a second layer of security, and administrators have detailed control over each action and transaction.

Using tokens is advantaged in saving calculation time of the generating hash everytime. Using tokens save processing time and improve efficiency, especially by reducing the need to repeatedly generate or validate hashes. Tokens are advantaged in reducing computation for each request. Upon authenticating with a token, the server does not need to recalculate a hash for every action; it just checks the token, which is a simpler, faster operation. This is especially beneficial for systems with high traffic where hashing could create a bottleneck.

Using tokens is further advantaged in session persistence, since the tokens maintain session-like states without needing continuous re-authentication. Once a token is generated and validated, it can be used repeatedly within its validity period, saving resources.

Using tokens is further advantaged in stateless authentication, particularly JWTs (JSON Web Tokens), are stateless. The server doesn't need to store session data, as the token itself contains the information required. This reduces server load and database calls.

Tokens save on hash calculations, among scalability benefits, making them highly efficient for handling repeated or high-frequency requests.

Controller 30B2 of gate 16B as well receives request 20A, and decodes request 20A to “JOE1”, “JOE2”, and “9.05”. Controller 30B2 of gate 16B approves “JOE2” in its database 26, and approves “9:05” upon checking in its clock, thus, controller 30B1 of gate 16A produces a different token code, such as 124, which transceiver 12B transmits to transceiver 12A. However, controller 30B2 of gate 16B as well rejects request 20A due to low transmittance intensity.

FIG. 2 depicts a second request to open the gate of FIG. 1.

At a second transmittance being while vehicle 14A is near, say 20 meters, transceiver 12A transmits a request 20B including the previously received token 40 of code “123”. Request 20B may further include the allowed code 22A1, being according to the example “JOE1”, combined with the current hour 34B, such as “9:06” retrieved from clock 24A.

Controller 30B1 receives request 20A from transceiver 12B, and approves token 40 of “123”.

Controller 30B1 as well finds sufficient intensity 32A of the transmittance, and thus approves request 20B, thus opens gate 16A.

Thus, the decision to open gate 16A is a function of the approved token 40 included in request 20B and its transmittance intensity 32A, after continuously approving allowed token 40 requests 20B, and requests thereafter, and comparing transmittance intensity 32A of each of approved requests 20B and requests thereafter. with a pre-determined intensity, for opening 16A only once transmittance intensity 32A of approved request 20B exceeds the pre-determined intensity.

Requests 20B and thereafter are automatically and continuously produced and transmitted while driving the vehicle. For example at distance 100 meters, 99 meters, 98 meters, etc., thus improving the distance resolution for opening the gate exactly upon arriving the gate, even at a high speed of driving the vehicle.

An interval between requests 20B and requests thereafter. may be determined. According to one embodiment the interval between request may be decreased upon decreasing the distance from the gate. For example at a distance of 200 meters, the interval between each request may be 2 seconds, whereas at a distance of 30 meters, the interval between each request may be 0.1 seconds.

The allowance of request 20A according to its allowed token 40 is an example for any secured transmission 36 whose intensity 32A may be measured by the receiver.

Request 20A may be allowed according to its allowed code 22A1 and an additional hooping/rolling code instead of current hour 34B, being another secured transmission 36 whose intensity 32A may be measured by the receiver.

The intensity of the transmission reaching the transceiver of the gate allows computing the distance of the vehicle from the gate.

The distance of the vehicle from the gate may as well be measured by a positioning tool 38 attached to the vehicle, such as by GPS.

Transceiver 12A may transmit the location of the vehicle as provided by positioning tool 38. The controller of the gate knows the gate's location and computes the distance of the vehicle, and opens the gate upon being nearer than a pre-determined distance.

Positioning tool 38 may as well obtain the speed of the vehicle. Transceiver 12A transmits the location and speed of the vehicle as provided by positioning tool 38. The controller of the gate knows the gate's location and computes the distance of the vehicle, and opens the gate upon a combination of the distance of the vehicle from the gate to be sufficiently near and of the vehicle's speed, which may include to have sufficient deceleration.

The position and speed of the vehicle within transmission 36 may as well be encrypted.

Secured transmission may apply 2.4 GHz Wi-Fi encrypted transmission including its Service Set IDentifier (SSID) and code 22A1.

Controller 30B1 may receive requests 20B and thereafter along time such that the intensity increases along time, and may open gate only at a pre-determined intensity, being only at the moment the vehicle enters the gate.

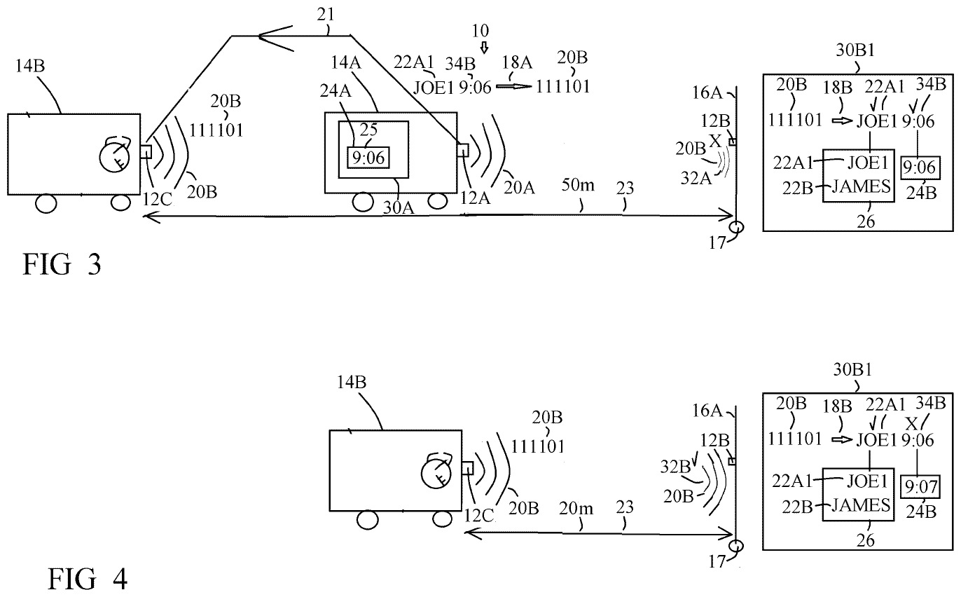

FIG. 3 depicts a third request to open the gate of FIG. 1.

In the example of FIG. 1 and FIG. 2, intensity 32A of the transmittance of the first request indicated 50 meters, and intensity 32A of the transmittance of the second request including token 40 indicated 20 meters. For the normal case of many requests, intensity 32A is expected to gradually increase. In case intensity 32A deviates from this expectation, controller 30B1 may dismiss token 40.

Thus, in case a non-allowed vehicle 14B of FIG. 3 including a non-allowed transceiver 12C reads (21) token 40 and attempts to enter by transmitting it, controller 30B1 will dismiss this token 40 combined with the indicated intensity, since its intensity deviates from the intensity transmitted by allowed transceiver 12A.

For example, controller 30B1 will not open the gate in case a third request including the approved token 40 or “123” indicates distance of 80 meters, since the 80 meters of the third request is not gradual between the 50 meters of the first request and the 20 meters of the second request being the sequential request of the third request. This 80 meters information indicates that non-allowed transceiver 12C has transmitted the third request.

Thus, the distance information, upon being sufficiently small functions for being a condition to open the gate; and further functions, at any value thereof, for checking the reliability of the password and of the token transmitted from the vehicle.

The clock may as well check the reliability. Suppose a non-allowed vehicle 14B disposed far from gate 16A, includes a non-allowed transceiver 12C, and receives (21) request 20B being according to the example code 111101, from allowed transceiver 12A, and transmits it, thus controller 30B1 receives request 20B from non-allowed transceiver 12C, and decodes (18) request 20B to “JOE1” and “9.06”.

Controller 30B1 approves “JOE1” in its database 26, since non-allowed transceiver 12C has copied the code from allowed transceiver 12A, and approves “9:06” upon checking in its clock 24B, thus, controller 30B1 of gate 16A provides the token code 123, which transceiver 12B transmits to transceiver 12C of the non-allowed vehicle. However, controller finds low transmittance intensity 32B, and thus rejects request 20B from transceiver 12C, thus closes gate 16A.

FIG. 4 depicts a fourth request to open the gate of FIG. 1.

Suppose non-allowed vehicle 14B including non-allowed transceiver 12C, has arrived the gate at time 9:07 near gate 16A and transmits

Controller 30B1 receives request 20B including token 40 of “123” from non-allowed transceiver 12C, and approves it. However, controller rejects “9:06” upon checking in its clock 24B time 9:07, even though controller now finds sufficiently high intensity 32B of the transmittance, and thus rejects request 20B from transceiver 12C, thus closes gate 16A.

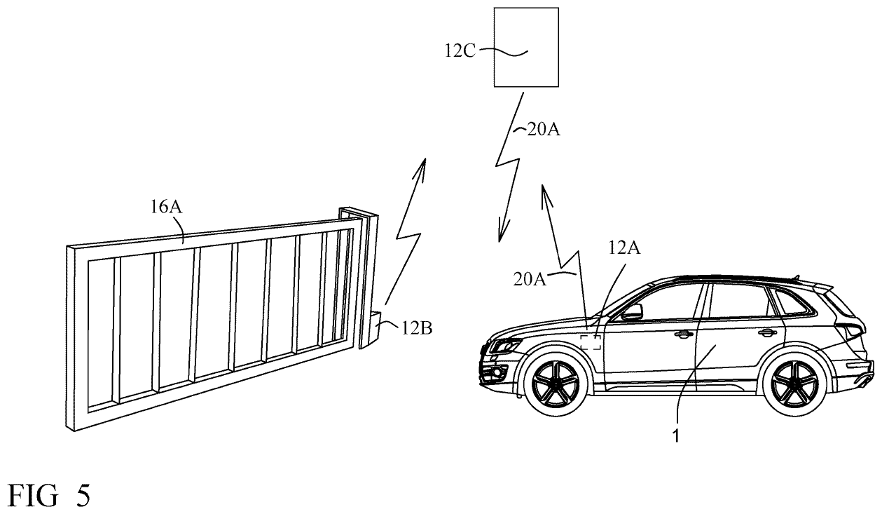

FIG. 5 depicts the contest between transceiver 12A and transceiver 12C.

Thus, transceiver 12A as being able to transmit the security code only and not another transmitter can open gate 16A and only at a certain moment being upon exceeding a pre-determined intensity, thus at a pre-determined distance.

Since already request 20A is approved regarding its security, the decision regarding the intensity requires less computing power, and thus is swift, thus high speed driving of the vehicle may open the gate a short time before arriving.

The first step is approving that a transceiver is allowed by identifying its code. This step requires a relatively large amount of computing power.

After approving that the transceiver is allowed (and only then), the second step is performed again and again to check whether the intensity from the allowed transceiver is sufficient. This step requires a relatively small amount of computing power, since once the transceiver was approved at the first step, its identification is already known to the receiver.

These two steps and their required computing power are since already request 20A is approved regarding its security, the decision regarding the intensity requires less computing power.

The advantageous result, that of opening the gate at the exact moment, even at high speed of driving towards the gate. The opening is thus swift, thus high speed driving of the vehicle may open the gate a short time before arriving.

Thus, in one aspect, the invention is directed to an automatic gate (16A) system (10), including:
a transceiver (12A), for continuously transmitting transmission (36) including requests (20A,20B) including
information including location of the transceiver (12A) in relation to the gate (16A), and
at least an allowed code (22A1); and
a device (30B1) for the gate (16A), including:
a) a transceiver (12B), for continuously receiving the continuous transmission (36); and
b) a controller (30B1) including the allowed code (22A1),
   for continuously approving the requests (20A,20B) according to the allowed code (22A1), and
   for opening the gate (16A) only once the requests (20A,20B) include the information of the transmitted transmission (36) indicating that the transceiver (12A) is sufficiently near the gate (16A).

The information may further includes speed and de-acceleration of the transceiver (12A) towards the gate (16A), and wherein the controller (30B1) is characterized to open the gate (16A) only once the requests (20A,20B) include the information of the transmitted transmission (36) indicating a combination of transceiver's (12A) distance from the gate (16A) and of at least one of the transceiver's (12A) speed and de-acceleration thereof.

The information including the location of the transceiver (12A) in relation to the gate (16A) transmitted by the transmission (36), includes location obtained from a positioning tool (38) attached to the transceiver (12A).

The location obtained from the positioning tool (38) and transmitted by the transmission (36), may be encrypted.

The transmission (36) may be intensity-measurable, and the information including the location of the transceiver (12A) in relation to the gate (16A) may include intensity of the transmission (36) as reaching to the transceiver (12B).

The at least allowed code (22A1) of the requests (20A,20B) transmitted by the transceiver (12A) may include at least two codes (22A1,22A2), thereby the requests (20A,20B) continuously transmitted by the transceiver (12A) may include the information including location of the transceiver (12A) in relation to the at least two gates (16A,16B), and the at least two codes (22A1,22A2), thereby the device (30B1) for each of the at least two gates (16A,16B) continuously receives the continuous transmission (36), and continuously approves the requests (20A,20B) according to one of the at least two codes (22A1,22A2), for opening its gate (16A) only once the requests (20A,20B) include the information of the transmitted transmission (36) indicating that the transceiver (12A) is sufficiently near that gate (16A).

The continuous transmitting of the transmission (36) may include intervals of the transmission.

The intervals within the transmission may decrease upon increasing the nearness of the transceiver (12A) to the gate (16A).

The requests (20A,20B) may further include time changing information.

The time changing information may be current time and/or a rolling code.

In the figures and description herein, the following reference numerals (Reference Signs List) have been mentioned:
numeral 10 denotes the vehicle gate system according to one embodiment of the invention;
12A: transceiver of vehicle 14A;
12B: transceiver of gate 16A;
14A,14B: vehicles;
16A: gate;
17: hinge of gate 16A;
18A: encoding;
18A: decoding;
20A,20B: requests to open gate 16A;
21: receipt of transmittance from one vehicle to another;
22A1: code encoded within request 20A allowed for gate 16A;
22A2: code encoded within request 20A allowed for gate 16B;
22B: another code allowed by controller 30B1 of gate 16A;
24A,24B: clocks;
25: current hour/time;
26: database within controller 30B1;
30A: controller of vehicle 14A;
30B1: controller of gate 16A;
32A: low intensity of transmittance of request 20A or 20B, indicating it is too early to open gate 16A;
32B: high intensity of transmittance of request 20A or 20B, indicating the vehicle has arrived and it is time to open;
34A: hour/time encoded within request 20A;
34B: hour/time encoded within request 20B;
36: secured transmission;
38: positioning tool;
40: token code;

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. An automatic gate system, comprising:
a transceiver of a vehicle, for continuously transmitting transmission, range thereof sufficient for transmitting a plurality of requests from the vehicle approaching at high speed, said transmission comprising requests comprising
information comprising location of said transceiver in relation to said gate,
at least an allowed code, for requesting to receive a token code, and
said token code upon said receipt thereof; and
a device for said gate, comprising
a) a transceiver, for continuously receiving said continuous transmission, and
b) a controller comprising said allowed code,
wherein said controller is
for producing said token code upon receiving a first request of said requests in case said first request comprises said allowed code, and
for opening said gate
once a request of additional requests of said requests comprises said produced token code combined with that said location information of said vehicle's transceiver indicates being sufficiently near said gate.

2. The gate system according to claim 1, wherein said information further comprises at least one of speed and de-acceleration of said transceiver towards said gate, and wherein said controller is characterized to open said gate only once said requests comprise said information of said transmitted transmission indicating a combination of said vehicle's transceiver's nearness to the gate and of at least one of the transceiver's speed and de-acceleration thereof.

3. The gate system according to claim 1, wherein said information comprising said location of said transceiver in relation to said gate transmitted by said transmission, comprises location obtained from a positioning tool attached to said transceiver.

4. The gate system according to claim 1, wherein said location obtained from said positioning tool and transmitted by said transmission, is encrypted.

5. The gate system according to claim 1,
wherein said transmission is intensity-measurable, and
wherein said information comprising said location of said transceiver in relation to said gate comprises intensity of said transmission as reaching to said transceiver.

6. The gate system according to claim 1,
wherein said at least allowed code of said requests transmitted by said transceiver comprises at least two codes, each for one of at least two gates,
thereby said requests continuously transmitted by said transceiver comprise said information comprising location of said transceiver in relation to said at least two gates, and said at least two codes.

7. The gate system according to claim 1, wherein said continuous transmitting of said transmission comprises intervals of said transmission.

8. The gate system according to claim 1, wherein said intervals within said transmission decrease upon increasing said nearness of said transceiver to said gate.

9. The gate system according to claim 1, wherein said requests further comprise time changing information.

10. The gate system according to claim 9, wherein said time changing information comprises at least one member selected from a group consisting of: current time; a rolling code.

11. The automatic gate system according to claim 1, wherein said controller is further for not opening said gate in case said location information of said request of said additional requests is not gradual in relation to said location information of a request being sequential to said request of said additional requests.
